(19) United States
(12) Patent Application Publication
(10) Pub. No.: US 2008/0168280 A1
(43) Pub. Date: Jul. 10, 2008

(54) Apparatus for improving computer security

(76) Inventors: Paul E. McKenney, Beaverton, OR (US); Paul J. Landsberg, Raleigh, NC (US); James P. Ward, Apex, NC (US); Andrew G. Kegel, Redmond, WA (US)

Correspondence Address: LAW OFFICES OF MICHAEL DRYJA, 1474 N COOPER RD #105-248, GILBERT, AZ, 85233, US

(21) Appl. No.: 12/053,580

(22) Filed: Mar. 22, 2008

Related U.S. Application Data
(63) Continuation of application No. 10/971,258, filed on Oct. 23, 2004.

(51) Int. Cl. G06F 12/14

(52) U.S. Cl. 713/194

(57) ABSTRACT

Indicating when the cover for a computer chassis has been opened is disclosed. A computer of an embodiment of the invention includes a chassis and a basic input/output system (BIOS), or another type of firmware. The chassis has an openable cover, and circuitry indicating when the openable cover has been opened. The BIOS has a non-volatile memory in which a flag is set when the circuitry indicates that the openable cover has been opened. The computer may further include always-on circuitry, such as time-of-day and real-time clock circuitry, to which the circuitry indicating when the openable cover has been opened is electrically connected. The computer may also include one or more encryption and/or signing modules that encrypt and/or sign data according to one or more keys. The keys are rendered invalid when the cover of the chassis has been opened.

### RELATED APPLICATIONS

The present patent application is a continuation of the previously filed patent application entitled “method and apparatus for improving computer security,” filed on Oct. 23, 2004, and assigned Ser. No. 10/971,258.

### FIELD OF THE INVENTION

The present invention relates generally to security systems for computers, and more particularly to security systems for computers deployed in untrusted locations.

### BACKGROUND OF THE INVENTION

Computers are frequently deployed for storing and processing sensitive information. For example, computers may store and process financial records or medical records. Such records may be alluring targets for hackers to obtain. Even non-sensitive applications may be targets for hacking. For instance, although web sites may not contain sensitive information like financial or medical records, the owners of the web sites do not want hackers to be able to modify the content of the web sites.

Traditionally, computer security has focused on ensuring that the computers cannot be accessed by unauthorized personnel electronically. For example, in order to access financial or medical records, users may have to enter one or more passwords, or have digital certificates, or keys, installed on the computers from which they are accessing the records. In the former case, correct entry of the passwords is required to access the records. In the latter case, the computer on which the records are stored will determine whether the digital certificates presented permit access. As an additional example, users may be able to access information on web sites without a password, but may not be able to modify the information without entering the correct password.

Furthermore, computers storing sensitive information or other information that is not to be modified by unauthorized personnel are preferably located in trusted locations. A trusted location is generally one to which physical access is limited. For example, for very sensitive banking applications, only a select few personnel may have access to the room housing the computers running these applications. Therefore, the potential for unauthorized users gaining physical access to the computers, to attempt to place electronic listening devices or other devices that require physical access, is limited. Even computers hosting web sites of large organizations are usually located in trusted locations, sometimes by third parties that guarantee only authorized personnel have access to the computers.

However, as information technology services have been increasingly deployed in a distributed fashion, it has become more difficult to locate computers only in trusted locations. For example, computers hosting web sites may be located around the globe, often in geographical places where it is becoming more difficult to find trusted locations. Deploying computers in untrusted locations, however, is fraught with risks. Administrators have to worry about unauthorized physical access to the computers, in addition to the usual unauthorized electronic access concerns. For example, electronic listening devices may be more easily placed by unauthorized personnel to attempt to discern encryption and other keys that would enable such people to decrypt sensitive encrypted information.

For these and other reasons, therefore, there is a need for the present invention.

### SUMMARY OF THE INVENTION

The invention relates generally to indicating when the cover for a computer chassis has been opened. A computer of an embodiment of the invention includes a chassis and a basic input/output system (BIOS), or other firmware. The chassis has an openable cover, and circuitry indicating when the openable cover has been opened. The BIOS has a non-volatile memory in which a flag is set when the circuitry indicates that the openable cover has been opened. The computer may further include always-on circuitry, such as time-of-day and real-time clock circuitry, to which the circuitry indicating when the openable cover has been opened is electrically connected. The computer may also include one or more encryption and/or signing modules that encrypt and/or sign data according to one or more keys. The keys are rendered invalid when the cover of the chassis has been opened.

A computer of another embodiment of the invention includes a chassis, non-volatile memory, and two means. The chassis has an openable cover. The first means is for generating a cover-open event when the openable cover has been opened. The second means is for setting a flag stored in the non-volatile memory in response to the cover-open event.

A chassis for a computer of an embodiment of the invention includes a housing, an openable cover for the housing, and a mechanism. Components of the computer are capable of being situated within the housing. The openable cover at least substantially prevents external access to the components of the computer when it is closed. The mechanism indicates when the openable cover has been opened. In another embodiment of the invention, there is a means for indicating when the openable cover has been opened, in lieu of the mechanism.

An article of manufacture of an embodiment of the invention includes a computer-readable medium and means in the medium. The means is for encrypting and/or signing data, by utilizing one or more keys. Each key includes a series of bits, including a single bit that is set based on whether an openable cover of a chassis for a computer has been opened. The series of bits of each key is invalid when this single bit has been set.

Embodiments of the invention provide for advantages over the prior art. Computers are more securely deployed in locations where security can be compromised. Although unauthorized personnel may have physical access to such computers, such people cannot physically open the covers for the computers without the computers recording this event. Where the circuitry indicating that the openable cover for a computer has been opened is electrically connected to always-on circuitry of the computer, the circuitry generates cover-open events even when the computer itself has been turned off.

Furthermore, some embodiments of the invention provide for linking the encryption and/or digital signing keys used by a computer to a flag that is set when the cover for the computer has been opened. For instance, a bit of such a key may be changed from logical zero to logical one, or vice-versa, when the cover has been opened. As a result, the key becomes invalid when the cover is opened, and an electronic listening device placed on the computer, for example, will not be able to discern the correct key. Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a computer having a chassis with an openable cover and a mechanism that is able to detect and indicate when the openable cover has been opened, according to an embodiment of the invention.

FIG. 2 is a diagram of an example computer architecture, in conjunction with which embodiments of the invention may be implemented.

FIG. 3 is a diagram of the computer of FIG. 1, depicting how the mechanism indicates when the openable cover has been opened, according to an embodiment of the invention.

FIG. 4 is a diagram of the computer of FIG. 1, depicting how indication from the mechanism that the openable cover has been opened can be used to modify encryption and/or signing keys, according to an embodiment of the invention.

FIG. 5 is a flowchart of a method for indicating that the openable cover of a chassis for a computer has been opened, according to an embodiment of the invention.

FIGS. 6A and 6B are diagrams of circuitry for detecting that the openable cover of a chassis for a computer has been opened, according to an embodiment of the invention, where in FIG. 6A the cover is closed and in FIG. 6B the cover is open.

FIGS. 7A and 7B are diagrams of additional circuitry for detecting that the openable cover of a chassis for a computer has been opened, according to another embodiment of the invention, wherein FIG. 7A the cover is closed and in FIG. 7B the cover is open.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview

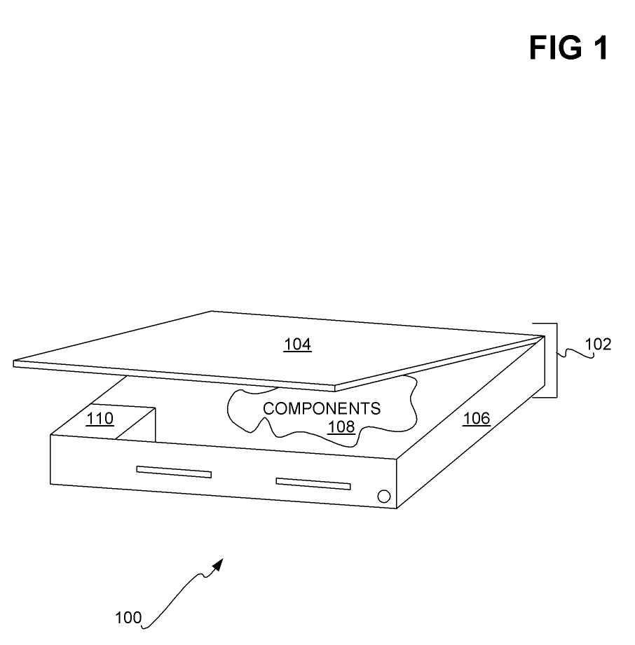

FIG. 1 shows a computer 100, according to an embodiment of the invention. The computer 100 includes a chassis 102. The chassis 102 may also be referred to as a case or as an enclosure. The chassis 102 may have a desktop, tower, rack-mount, or other form factor. The chassis 102 includes an openable cover 104 and a housing 106. The openable cover 104 is shown in FIG. 1 as being open. The openable cover 104 may also be removable, in which case it may be referred to as a removable cover or lid. Although the openable cover 104 is depicted as being on the top of the housing 106, and the housing 106 on the bottom of the openable cover 104, such depiction in FIG. 1 is for illustrative purposes only. In other embodiments of the invention, the openable cover 104 may be on the side of the housing 106, on the bottom of the housing 106, and so on.

The chassis 102 encloses internal components 108 of the computer 100. More specifically, in the embodiment of FIG. 1, the internal components 108 are housed within the housing 106 of the chassis 102. These internal components 108 may include hard disk drives, memory, processors, motherboards or mainboards, power supplies, and so on. When the openable cover 104 is closed, it at least substantially prevents external access to the components 108 of the computer 108. The openable cover 104 may be locked to the housing 106 when it is closed, although such locking capability is not specifically depicted in FIG. 1.

The chassis 102 further includes a mechanism 110 that detects and indicates when the openable cover 104 has been opened. Details regarding how the mechanism 110 detects when the openable cover 104 has been opened, and how it indicates when the openable cover 104 has been opened, are particularly described in subsequent sections of the detailed description. However, the presence of the mechanism 110 enables the computer 100 to be more securely deployed in locations where there are higher chances that the computer security can be compromised. That is, presuming that the internal components 108 are not externally accessible unless the openable cover 104 has been opened, if the mechanism 110 does not detect the openable cover 104 having been opened, then it can be concluded that an unauthorized personnel have not physically accessed the internal components 108. Although the mechanism 110 is depicted as being in the front left corner of the housing 106, such depiction in FIG. 1 is for example purposes only, and in other embodiments of the invention, the mechanism 110 may be located elsewhere within the chassis 102.

### Technical Background

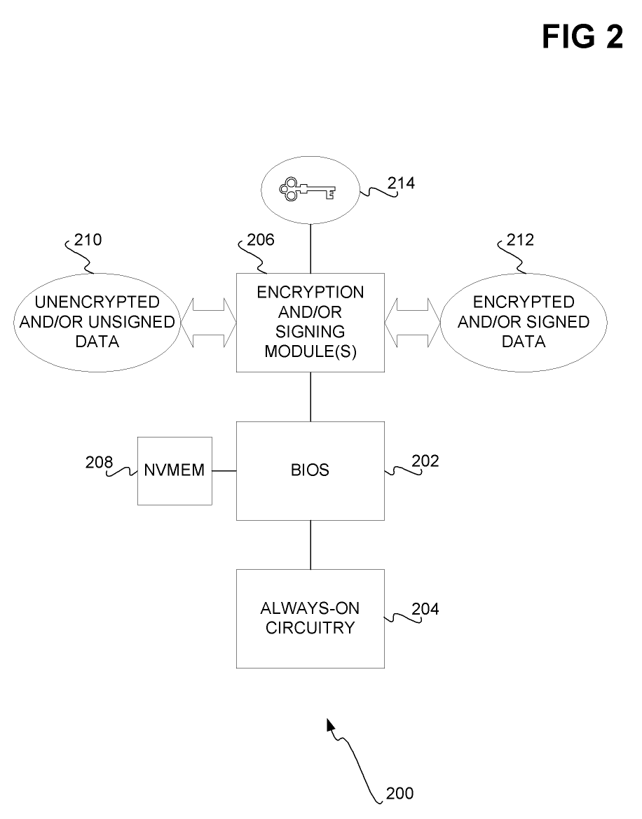

FIG. 2 shows an examplary computer architecture 200, in accordance with which embodiments of the invention may be implemented. The computer 100 of FIG. 1, for instance, may have the computer architecture 200 of FIG. 2 in one embodiment of the invention. Not all components of an actual computer architecture are depicted in FIG. 2, and the computer architecture 200 may include other components, in addition to and/or in lieu of those depicted in FIG. 2. As shown in FIG. 2, the computer architecture 200 includes a basic input/output system (BIOS) 202, always-on circuitry 204, and one or more encryption and/or signing modules 206.

The BIOS 202 is a set of computer code of the computer architecture 200, which is typically stored on a semiconductor integrated circuit (IC), and provides an interface between an operating system of the computer and the hardware of the computer. The BIOS 202 supports peripheral technologies, as well as internal services. The BIOS interfaces with non-volatile memory 208 that retains its contents even when power is not supplied to the memory 208. On startup of the computer, the BIOS 202 tests the computer and prepares it for operation by querying the non-volatile memory 208 for configuration settings. It searches for any other BIOS's and sets up pointers, or interrupt vectors, in memory to access these routines. The BIOS 202 then loads the operating system and passes control to it. The BIOS 202 accepts requests from the drivers as well as from application programs running on the operating system. It is noted that the BIOS 202 is one type of firmware, and although the preferred embodiment of the invention is described in relation to BIOS, the invention generally is applicable to any type of firmware.

The always-on circuitry 204 is circuitry that has a small power source such that it remains on even when the rest of the computer architecture 200 has been turned off, or when the rest of the computer architecture 200 has had external power, such as alternating current (AC) power received from a wall outlet, removed therefrom. The always-on circuitry 204 may be or include real-time clock and date circuitry, which maintains the current time and date even when the computer architecture 200 has been turned off, via inclusion of a small long-life battery. The BIOS 202 interfaces with the always-on circuitry 204 in this embodiment, such that it retrieves the current time and date from the circuitry 204 and supplies it to the rest of the computer as needed.

The encryption and/or signing modules 206 may be or include hardware, software, or a combination of hardware and software. The modules 206 can input unencrypted and/or unsigned data 210, and encrypt and/or sign the data 210 to result in the encrypted and/or signed data 212. Furthermore, the modules 206 may input the encrypted data 212 and decrypt the data 212 to result in the decrypted, or unencrypted, data 210. The modules 206 may also input the signed data 212 and determine the identity of the signer of the signed data 212. To perform signing, encryption, and decryption, the modules 206 utilize one or more encryption and/or signing keys 214. Each of the keys 214 may include a series of bits, by which the modules 206 sign, encrypt, or decrypt data according to a given encryption or signing scheme, as can be appreciated by those of ordinary skill within the art. In one embodiment of the invention, one or more bits of the keys 214 may be based on information stored in the non-volatile memory 208, and/or may be stored in the non-volatile memory 208.

The signed data 212 is signed in that the data has been processed with a digital signature or certificate, which is itself a series of bits associated typically with a user. Processing of data to result in signed data means that the data has been changed such that it is still in user-readable form, but has been modified so that subsequent verification can be made to determine the identity of the user whose digital signature or certificate signed the data. For instance, when presented with signed data and a given digital signature or certificate, whether the given digital signature or certificate was used to generate the signed data can be determined. In this way, the identity of the user who signed the data can be determined whether the digital signature or certificate of this user is known. Data signing is useful in situations where it is important to know who the owner or generator of data is. Where the data is signed by the digital signature or certificate of the owner or generator of the data, then the identity of this owner or generator can later be verified.

Encrypting the data 210 transforms it into a difficult-to-interpret format, as the data 212, to protect its confidentiality, integrity and sometimes its authenticity. Encryption process uses an encryption algorithm and the encryption keys 214. Decryption process thus decrypts the encrypted data 212 into an again-utilizable format, as the data 210. Signing the data 210 provides a digital guarantee that a file has not been altered. Signing the data 210 results in a digital signature of the data 210, as part of the data 212, which is an encrypted digest, or one-way hash function, of the data 210, using the signing keys 214. The recipient decrypts the digest that was sent and also recomputes the digest. If the digests match, the file is proved intact and tamper free from the sender.

### Example Implementations

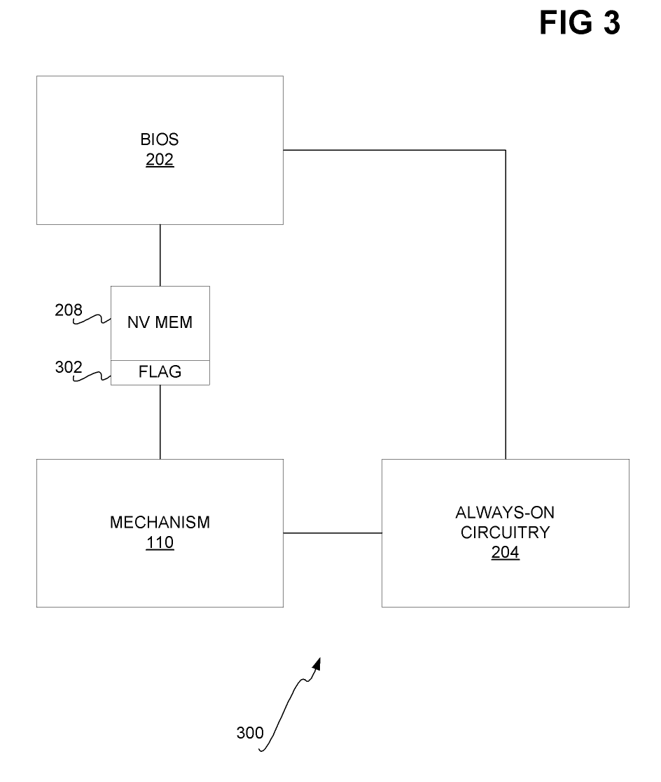

FIG. 3 shows a computer 300 in which the mechanism 110 indicates whether the openable cover 104 of FIG. 1 has been opened by having such information stored in the non-volatile memory 208, according to an embodiment of the invention. The computer 300 of FIG. 3 may in one embodiment be the computer 100 of FIG. 1. The computer 300 is depicted in FIG. 3 as including the mechanism 110, the BIOS 202, the non-volatile memory 208, and the always-on circuitry 204. The computer 300 also includes the other parts of the computer 100 depicted in FIG. 1, which are not shown in FIG. 3 for illustrative clarity. The computer 300 may further include all or some of the other parts depicted in FIG. 2, in other embodiments of the invention.

The mechanism 110 is electrically connected to the always-on circuitry 204 in one embodiment of the invention. Such electrical connection enables the mechanism 110 to detect opening of the openable cover 104 of FIG. 1 even when the computer 300 is off, or when electrical power has been removed from the computer 300. In other embodiments of the invention, the mechanism 110 may itself include an internal power source so that it remains always on, and is able to detect opening of the openable cover 104 even when the computer 300 is off, instead of being electrically connected to the circuitry 204.

The mechanism 110 and the BIOS 202 interact in one embodiment as follows. The mechanism 110 detects that the openable cover 104 of FIG. 1 has been opened, as is described in more detail in subsequent sections of the detailed description. The mechanism 110 then sets a flag 302 in the non-volatile memory 208, to indicate that the openable cover 104 has been opened. The flag 302 may be a single bit flag in one embodiment of the invention where, for instance, a value of logical zero corresponds to the flag 302 being cleared and the openable cover 104 not having been opened, and a value of logical one corresponds to the flag 302 being set and the openable cover 104 having been opened. The flag 302 remains set once the openable cover 104 has been opened, even after the cover 104 is subsequently closed.

The mechanism 110 and the BIOS 202 interact in another embodiment as follows. The mechanism 110 detects that the openable cover 104 of FIG. 1 has been opened, and in response generates a cover-open event. In response to the cover-open event, the BIOS 202, or an operating system running on the computer 300 in another embodiment of the invention, sets the flag 302 in the non-volatile memory 208. In either embodiment, therefore, the flag 302 is set once the openable cover 104 has been opened, due to the mechanism 110 detecting the cover 104 having been opened.

The BIOS 202 may enable the user to clear the flag 302 in the non-volatile memory 208 after it has been set. For instance, an authorized user may be performing regular maintenance on the computer 300 that requires opening of the openable cover 104 of FIG. 1. After closing the cover 104 and rebooting the computer 300, the user may then access the BIOS 202 to clear the flag 302, since the user knows that it was his or her opening of the openable cover 104 that caused the flag 302 to be set. The user may have to enter a password to access the BIOS 202, so that unauthorized users cannot clear the flag 302 within the BIOS 202.

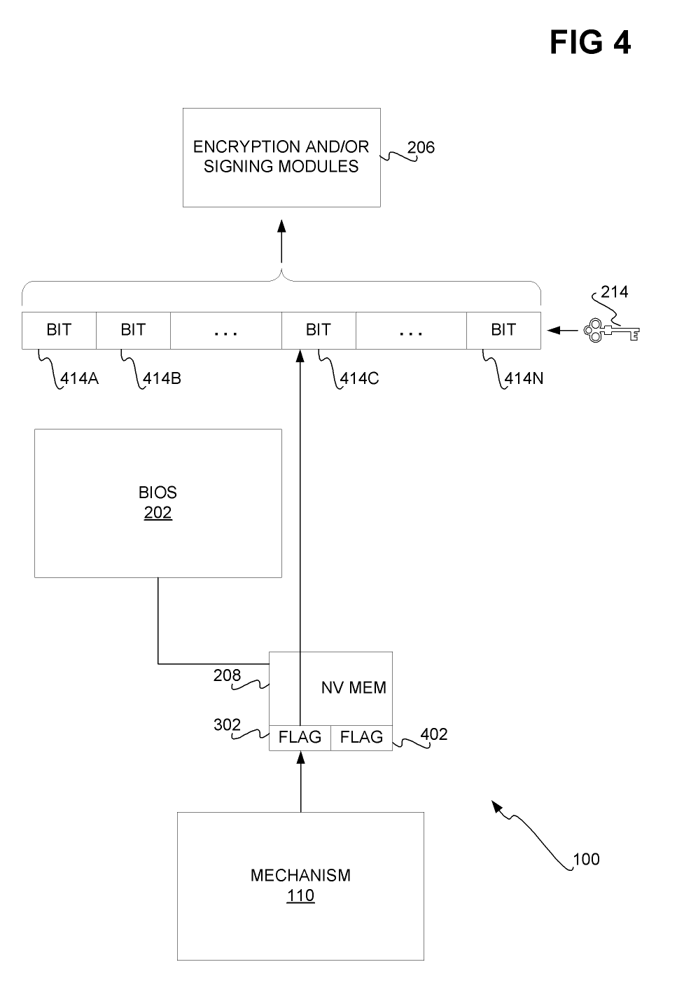

FIG. 4 shows the computer 100 in which the flag 302 is used as a bit of the encryption and/or signing keys 214, according to an embodiment of the invention. The computer 100 is depicted in FIG. 4 as including the mechanism 110, the BIOS 202, the non-volatile memory 208, and the encryption and/or signing modules 206. The computer 100 also includes the other parts thereof depicted in FIG. 1, which are not shown in FIG. 4 for illustrative clarity. The computer 100 may further include all or some of the other parts depicted in FIGS. 2 and/or 3, in other embodiments of the invention.

The encryption and/or signing keys 214 include a number of bits 414A, 414B, 414C, . . . , 414N, collectively referred to as the bits 414. One of the bits 414, for example bit 414C, is specifically equal to and/or based on the flag 302 stored in the non-volatile memory 208 that corresponds to whether the openable cover 104 of FIG. 1 has been opened. The keys 214 are valid when the flag 302 is cleared. When the flag 302 is set, the bit 414C changes, changing the keys 214, and resulting in the keys 214 becoming invalid, since one of the bits 414, the bit 414C, has changed.

For instance, in one embodiment, the mechanism 110 or the BIOS 202 sets a single bit of the flag 302 from logical zero to logical one when the mechanism 110 detects that the openable cover 104 of FIG. 1 has been opened. Changing the single bit of the flag 302 results in the bit 414C of the keys 214 being changed. The bit 414C may be directly tied to the flag 302, such that changing the single bit of the flag 302 automatically results in the bit 414C changing as well. Alternatively, the bit 414C may just be based on the flag 302, where the modules 206 or the BIOS 202 changes the bit 414C in response to the flag 302 having been changed.

In one embodiment, a second flag 402 is stored in the non-volatile memory 208. The flag 402 is set by an authorized user by accessing the BIOS 202, which may be password protected. The flag 402 indicates generally whether or not to respond to setting of the flag 302, such as whether to render the keys 214 invalid in response to setting the flag 302. For instance, setting the flag 402 may indicate that the user wishes the bit 414C of the keys 214 to change, resulting in the keys 214 becoming invalid, when the flag 302 is set as a result of the mechanism 110 detecting opening of the openable cover 104 of FIG. 1. Clearing the flag 402 may thus indicate that the user wishes the bit 414C of the keys 214 not to change, so that the keys 214 remain valid, even when the flag 302 is set.

In one embodiment, each of the flags 302 and 402 is equal to logical one when it is set, and to logical zero when it is cleared. Therefore, performing a logical AND operation on the flags 302 and 402 yields logical one when both of the flags 302 and 402 have been set. Thus, the bit 414C may in one embodiment be equal to the logical AND of the flags 302 and 402, where when the bit 414C is logical zero, the keys 214 are valid. The keys 214 will only be invalid when the bit 414C is logical one, which results only when the flag 402 is set, corresponding to desiring to respond to setting of the flag 302, and when the flag 302 is set, corresponding to when the openable cover 104 has been opened. Other approaches may also be used to logically manipulate and evaluate the flags 302 and 402.

Unauthorized users who may have been able to open the openable cover 104 of FIG. 1 to, for example, place listening devices within the computer 100 to surreptitiously glean the encryption and/or signing keys 214 are nevertheless stymied. The keys 214 change because opening of the cover 104 results in the flag 302 being set, and thus one of the bits 414 of the keys 214, the bit 414C in this example, changing. The keys 214 become invalid. Therefore, even if the listening devices placed within the computer 100 successfully glean the keys 214, the keys 214 are invalid, rendering them useless to the unauthorized users who placed the listening devices within the computer 100.

The bits 414, and more generally the keys 214 and the flag 302, are in one embodiment part of what is known and referred to as a measurement taken by the modules 206, where the modules 206 include a Trusted Platform Module (TPM), which is a repository for encryption, signing, and other types of keys. Further information regarding TPM's is found at the Internet web site www.trustedcomputing.org/home. A measurement as used in this context is a set of values written to registers of the TPM. In this embodiment, there is no way to access the bits 414, the keys 214, and the flag 302, except through the TPM of the modules 206. The TPM itself encrypts this information using the measurement, such that the TPM is not concerned what the measurement relates to, and only that the values obtained are correct. For instance, one use of a TPM measurement is a trusted boot, in which a signature of the BIOS and the operating system are placed in the TPM measurement registers. If the BIOS or the operating system is changed, the signature changes, such that the values written to the TPM measurement registers also change, rendering the information stored in the TPM inaccessible.

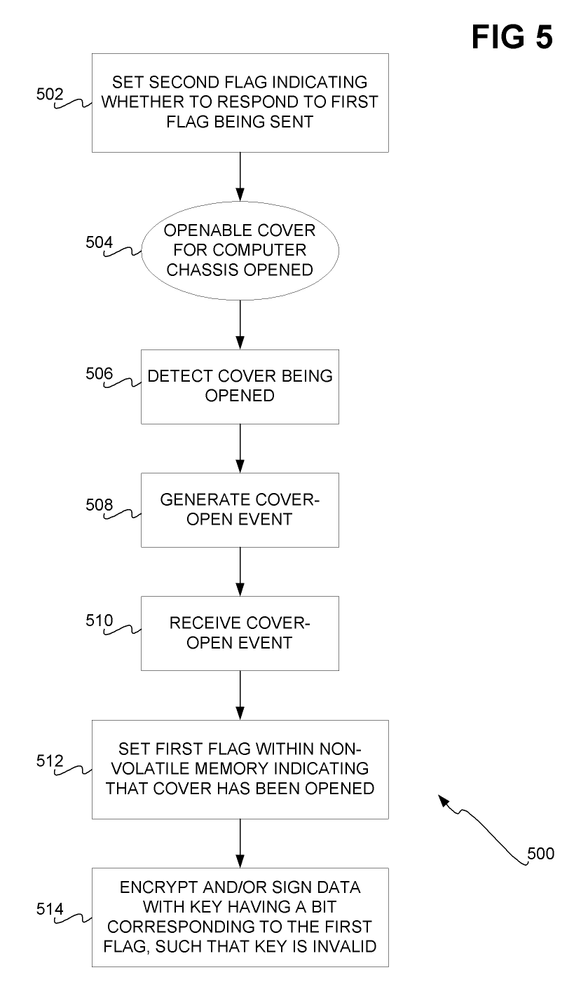

FIG. 5 shows a method 500 that summarizes the operation of the computer 100 as to the opening of the openable cover 104 thereof, according to one embodiment of the invention. At least some parts of the method 500 may be implemented as a computer program stored on a computer-readable medium of an article of manufacture. The medium may be a recordable data storage medium, a modulated carrier signal, or another type of computer-readable medium.

A user sets the second flag 402 to indicate that a response should be made to the first flag 302 being set (502). For instance, the response may be to render the encryption and/or signing keys 214 invalid. The openable cover 104 of the chassis 102 of the computer 100 is then opened (504). In response, the mechanism 110 detects the cover 104 being opened (506), and generates a cover-open event (508).

The BIOS 202 receives the cover-open event (510), and sets the first flag 302 within the non-volatile memory 208 to indicate that the openable cover 104 has been opened (512). As has been noted, alternatively the mechanism 110 itself may set the first flag 302 within the non-volatile memory 208, instead of sending a cover-open event to the BIOS 202. Thereafter, encrypting and/or signing data by the encryption and/or signing modules 206 results in invalid encryption and signing, where the keys 214 each have a bit corresponding to the flag 302, such that setting the flag 302 results in the keys 302 becoming invalid (514), as has been described.

### Example Mechanisms to Detect Opening of Openable Cover of Computer Chassis

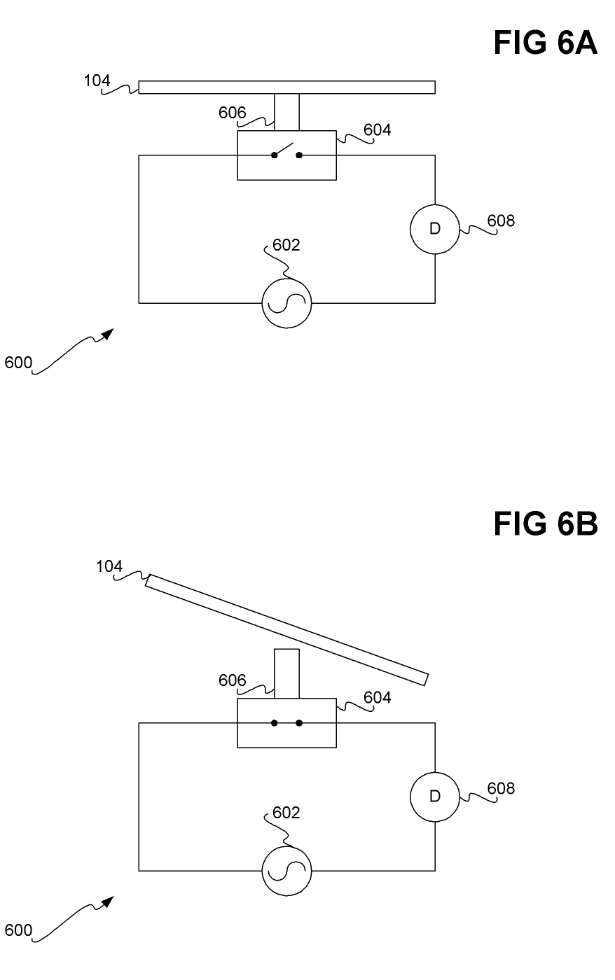

FIGS. 6A and 6B show circuitry 600 to detect the opening of the openable cover 104 of the chassis 102 of the computer 100, according to an embodiment of the invention. The mechanism 110 that has been described can in one embodiment be or include the circuitry 600 of FIGS. 6A and 6B. In FIG. 6A, the cover 104 is closed. The openable cover 104 makes contact with a push button 606 of a normally closed switch 604. Since the cover 104 is closed and has actuated the button 606 of the switch 604, the switch 604 is open. Thus, power from a power source 602 does not result in current within the circuit 600, and a current detector 608 does not detect any current flowing. In one embodiment, the power source 602 may be or include the always-on circuitry 204.

In FIG. 6B, the openable cover 104 has been opened. The cover 104 no longer makes contact with the push button 606 of the switch 604, and the switch 604 has returned to its normally closed position. Therefore, power from the power source 602 flows within the circuit 600, which is detected by the current detector 608. Detection of current by the current detector 608 thus is the manner by which the circuitry 600 of FIGS. 6A and 6B detects that the openable cover 104 has been opened.

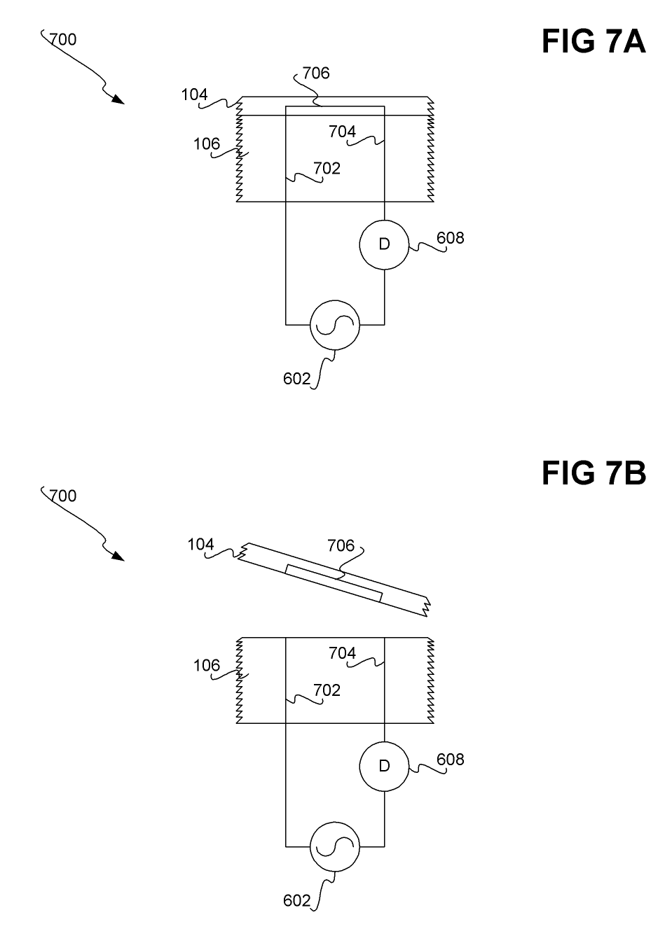

FIGS. 7A and 7B show the circuitry 700 to detect the opening of the openable cover 104 of the chassis 102 of the computer 100, according to another embodiment of the invention. The mechanism 110 that has been described can in one embodiment be or include the circuitry 700 of FIGS. 7A and 7B. In FIG. 7A, the cover 104 is closed onto the housing 106. Traces 702 and 704 of the housing 106 are electrically connected by a trace 706 of the openable cover 104. Therefore, power from the power source 602 results in current flowing within the circuit 700, which the current detector 608 detects.

In FIG. 7B, the openable cover 104 has been opened. The traces 702 and 704 of the housing 106 are no longer electrically connected by the trace 706 of the cover 104. Therefore, power from the power source 602 does not result in current flowing within the circuit 700, and the current detector 608 does not detect any current. Detection of no current by the current detector 608 thus is the manner by which the circuitry 700 of FIGS. 7A and 7B detects that the openable cover 104 has been opened.

### CONCLUSION

It is noted that, although specific embodiments have been illustrated and described herein, it will be appreciated by those of ordinary skill in the art that any arrangement calculated to achieve the same purpose may be substituted for the specific embodiments shown. For instance, whereas embodiments of the invention have been described in relation to using a flag set when the openable cover of a computer has been opened in conjunction with encryption and/or signing keys, other embodiments of the invention may be used in relation to other applications. As a further example, whereas two specific embodiments of circuitry that can detect the opening of the openable cover of the computer have been described, other embodiments may employ different types of circuitry. This application is intended to cover any adaptations or variations of embodiments of the present invention. It is manifestly intended that this invention be limited only by the claims and equivalents thereof.

We claim:

1. A computer comprising:
a chassis having an openable cover and circuitry indicating when the openable cover has been opened;
a firmware to set a flag in a non-volatile memory when the circuitry indicates that the openable cover has been opened; and,
one or more encryption and/or signing modules that encrypt and/or sign data based on the flag, such that the encryption module is unable to encrypt and/or sign the data when the flag is set.

2. The computer of claim 1, wherein the circuitry generates a cover-open event when the openable cover has been opened, the firmware setting the flag in the non-volatile memory in response to generation of the cover-open event.

3. The computer of claim 1, further comprising always-on circuitry to which the circuitry indicating when the openable cover has been opened is electrically connected.

4. The computer of claim 3. wherein the always-on circuitry comprises time-of-day and real-time clock circuitry.

5. The computer of claim 1, wherein the circuitry comprises a switch that is open when the openable cover is closed and that is closed when the openable cover is open.

6. The computer of claim 1, wherein the openable cover comprises a removable lid.

7. The computer of claim 1, wherein the modules comprise an encryption module that encrypts data, the encryption module unable to encrypt the data when the flag is set.

8. The computer of claim 7, wherein the flag comprises a bit, the encryption module encrypting the data according to an encryption key, the encryption key including the bit corresponding to the flag being cleared.

9. The computer of claim 1, wherein the modules comprise a signing module that signs data, the signing module unable to sign the data when the flag is set.

10. The computer of claim 9, wherein the flag comprises a bit, the signing module signing the data according to a signing key, the signing key including the bit corresponding to the flag being cleared.

11. The computer of claim 1, wherein the non-volatile memory stores a second flag indicating whether to respond to the flag being set when the circuitry indicates that the openable cover has been opened.

12. The computer of claim 11, further comprising at least one of:
an encryption module that encrypts data, the encryption module unable to encrypt the data when the flag and the second flag are both set;
a signing module that signs data, the signing module unable to sign the data when the flag and the second flag are both set; and,
an encryption and signing module that encrypts and signs data, the encryption module unable to encrypt or sign the data when the flag and the second flag are both set.

13. The computer of claim 11, wherein the flag and the second flag each comprises a bit that is logical zero when cleared and logical one when set, such that performing a logical AND operation on the flag and the second flag yields logical one when both the flag and the second flag have been set.

14. The computer of claim 1, wherein the firmware provides for the flag to be cleared after the flag has been set.

15. An article of manufacture comprising:
a computer-readable medium; and,
means in the medium for encrypting and/or signing data by utilizing one or more keys, each key comprising a series of bits including a single bit that is set based on whether an openable cover of a chassis for a computer has been opened,
such that the series of bits of each key is invalid when the single bit is set.

16. The article of claim 15, wherein the single bit results from performance of a logical AND operation of a first bit that is set to logical one when the openable cover is open and is set to logical zero when the openable cover is closed, and a second bit.

17. The article of claim 16, wherein the second bit is set to logical one to indicate that opening of the openable cover is to invalidate the one or more keys, and is set to logical zero to indicate that opening of the openable cover is not to invalidate the one or more keys.

18. The article of claim 15, wherein the medium is one of a recordable data storage medium and a modulated carrier signal.
